(19) United States
(12) Patent Application Publication
(10) Pub. No.: US 2021/0158553 A1
(43) Pub. Date: May 27, 2021

(54) IMAGE PROCESSING DEVICE AND NON-TRANSITORY MEDIUM

(71) Applicant: SHARP KABUSHIKI KAISHA, Sakai City, Osaka (JP)

(72) Inventors: TAKUTO ICHIKAWA, Sakai City, Osaka (JP); MAKOTO OHTSU, Sakai City, Osaka (JP); TAICHI MIYAKE, Sakai City, Osaka (JP); KEI TOKUI, Sakai City, Osaka (JP)

(73) Assignees: SHARP KABUSHIKI KAISHA, Sakai City, Osaka (JP); SHARP KABUSHIKI KAISHA, Sakai City, Osaka (JP)

(21) Appl. No.: 16/484,388

(22) PCT Filed: Dec. 28, 2017
(86) PCT No.: PCT/JP2017/047262

§ 371 Date: Aug. 7, 2019

(30) Foreign Application Priority Data
Feb. 10, 2017 (JP) 2017-023586

(51) Int. Cl. G06T 7/536; G06K 9/00; G06T 15/20; G06T 7/73; G06T 7/11

(52) U.S. Cl. CPC G06T 7/536; G06K 9/00671; G06T 7/11; G06T 7/73; G06T 15/20

(57) ABSTRACT

To determine, by image processing, a position at which visual information is to be displayed in a superimposed manner or a position at which visual information is not to be displayed in a superimposed manner. An image processing device (1A) includes a control unit (201) configured to superimpose visual information on an input image, and the control unit (201) determines a position at which the visual information is to be superimposed based on differential information indicating at least one of a difference between pixel values in the input image and a difference between the input images.

### TECHNICAL FIELD

The present disclosure relates to an image processing device and an image processing program that superimpose visual information on an input image.

### BACKGROUND ART

In recent years, Augmented Reality (AR) technology has been developed in which visual information such as a graphic, a character, a still image, and a video is superimposed and displayed on an image presenting a real space. According to the AR technology, for example, a video or the like presenting a working method can be superimposed on a work object at a work site, or a diagnostic image or the like can be superimposed on a patient's body at a medical site.

Examples of an implementation method of the AR technique include an optical see-through type in which visual information is superimposed on a real space by using a half mirror or the like to present a resulting superimposition image, and a video see-through type in which a real space is captured with a camera, visual information is superimposed on the captured image to present a resulting superimposition video. A preferable technology is adopted depending on an intended use.

Here, the video see-through type AR technology has a problem in that the superimposed visual information hides the real space and impairs visibility of the real space. In order to deal with this problem, PLT 1 discloses a method in which priorities of regions in each of which visual information is displayed are listed in advance, and a position, size, and shape of the visual information are changed according to the list.

### CITATION LIST

### Patent Literature

PTL 1: JP 2012-69111 A (published on Apr. 5, 2012)

### SUMMARY OF INVENTION

### Technical Problem

The technique described in PTL 1 needs to pre-generate a list of displayable regions for superimposed information. For this reason, the technique described in PTL 1 can be used only in a situation where a captured location is identified, such as a board game. Specifically, the method described in PTL 1 cannot be used at an arbitrary location, for example, in a case of being utilized outdoors.

Therefore, the present inventors have diligently studied the technology determining, by image processing, a position at which visual information is to be displayed in a superimposed manner, or a position at which visual information is not to be displayed in a superimposed manner, based on their unique ideas. In a case that the position at which visual information is to be displayed in a superimposed manner, or the position at which visual information is not to be displayed in a superimposed manner can be determined by image processing, the visual information can be displayed in a superimposed manner on an appropriate position at various locations. However, there is no known document reporting image processing that can be used to determine a position at which visual information is to be displayed in a superimposed manner, or a position at which visual information is not to be displayed in a superimposed manner.

An aspect of the present disclosure has been made in light of the problems described above, and an object of the aspect of the present disclosure is to provide an image processing device and an image processing program that determine, by image processing, a position at which visual information is to be displayed in a superimposed manner, or a position at which visual information is not to be displayed in a superimposed manner.

### Solution to Problem

In order to solve the above-described problem, an image processing device according to an aspect of the present disclosure includes an image processing unit configured to superimpose visual information on an input image, wherein the image processing unit determines a position at which the visual information is to be superimposed based on differential information for indicating at least one of a difference between pixel values in the input image and a difference between the input images.

In order to solve the above-described problem, an image processing device according to an aspect of the present disclosure includes an image processing unit configured to superimpose visual information on an input image, wherein the image processing unit determines a range in which the visual information is not to be superimposed based on differential information for indicating at least one of a difference between pixel values in the input image and a difference between the input images.

In order to solve the above-described problem, an image processing device according to an aspect of the present disclosure includes an image processing unit configured to superimpose visual information on an input image, wherein the image processing unit detects a moving object from the input image, and performs switching whether to superimpose the visual information, based on at least one of a position and a movement direction of the moving object detected.

In order to solve the above-described problem, an image processing program according to an aspect of the present disclosure causes a processor, the processor being included in an image processing device for superimposing visual information on an input image, to perform superimposed position determination processing to determine a position at which the visual information is to be superimposed based on differential information for indicating at least one of a difference between pixel values in the input image and a difference between the input images.

In order to solve the above-described problem, an image processing program according to an aspect of the present disclosure causes a processor, the processor being included in an image processing device for superimposing visual information on an input image, to perform non-superimposition region determination processing to determine a range in which the visual information is not to be superimposed based on differential information for indicating at least one of a difference between pixel values in the input image and a difference between the input images.

In order to solve the above-described problem, an image processing program according to an aspect of the present disclosure causes a processor, the processor being included in an image processing device for superimposing visual information on an input image, to perform superimposition switching processing to detect a moving object from the input image, and perform switching whether to superimpose the visual information based on at least one of a position and a movement direction of the moving object detected.

### Advantageous Effects of Invention

According to an aspect of the present disclosure, an effect is exhibited that a position where visual information is displayed in a superimposed manner or a position where visual information is not displayed in a superimposed manner can be determined by image processing.

### BRIEF DESCRIPTION OF DRAWINGS

FIG. 1 is a diagram schematically illustrating an example of a usage aspect of an image processing device according to an embodiment of the present disclosure.

FIG. 2 is a diagram illustrating an example of a functional block configuration of the image processing device illustrated in FIG. 1.

FIG. 3 is a diagram illustrating in detail a portion of the functional block configuration illustrated in FIG. 2.

FIG. 4 is a diagram illustrating a state in which an input image is displayed on a display unit of the image processing device illustrated in FIG. 1.

FIG. 5 is a diagram schematically illustrating a portion of processing of the image processing device illustrated in FIG. 1.

FIG. 6 is a diagram schematically illustrating a portion of the processing of the image processing device illustrated in FIG. 1.

FIG. 7 is a diagram illustrating a processing flow of the image processing device illustrated in FIG. 1.

FIG. 8 is a diagram illustrating an example of a functional block configuration of an image processing device according to another embodiment of the present disclosure.

FIG. 9 is a diagram illustrating in detail a portion of the functional block configuration illustrated in FIG. 8.

FIGS. 10A to 10C are diagrams each of which schematically illustrates a portion of processing of the image processing device illustrated in FIG. 8.

FIG. 11 is a diagram schematically illustrating a portion of the processing of the image processing device illustrated in FIG. 8.

FIG. 12 is a diagram illustrating a processing flow of the image processing device illustrated in FIG. 8.

FIG. 13 is a diagram illustrating an example of a functional block configuration of an image processing device according to another embodiment of the present disclosure.

FIG. 14 is a diagram illustrating in detail a portion of the functional block configuration illustrated in FIG. 13.

FIG. 15 is a diagram illustrating a processing flow of the image processing device illustrated in FIG. 13.

FIGS. 16A and 16B are diagrams each of which schematically illustrates a state in which an input image and visual information displayed in a superimposed manner on the input image are displayed on the display unit of the image processing device illustrated in FIG. 1.

FIGS. 17A and 17B are diagrams each of which schematically illustrates a state in which an input image and visual information displayed in a superimposed manner on the input image are displayed on the display unit of the image processing device illustrated in FIG. 1.

FIG. 18 is a diagram schematically illustrating a state in which an input image and visual information displayed in a superimposed manner on the input image are displayed on the display unit of the image processing device illustrated in FIG. 1.

FIG. 19 is a diagram schematically illustrating an example of a usage aspect of an image processing device according to another embodiment of the present disclosure.

FIG. 20 is a diagram schematically illustrating a state in which a moving object is detected in the image processing device of the aspect illustrated in FIG. 19.

FIG. 21 is a diagram schematically illustrating an example of a usage aspect of an image processing device according to another embodiment of the present disclosure.

FIG. 22 is a diagram schematically illustrating a state in which a moving object is detected in the image processing device of the aspect illustrated in FIG. 21.

### DESCRIPTION OF EMBODIMENTS

### Embodiment 1

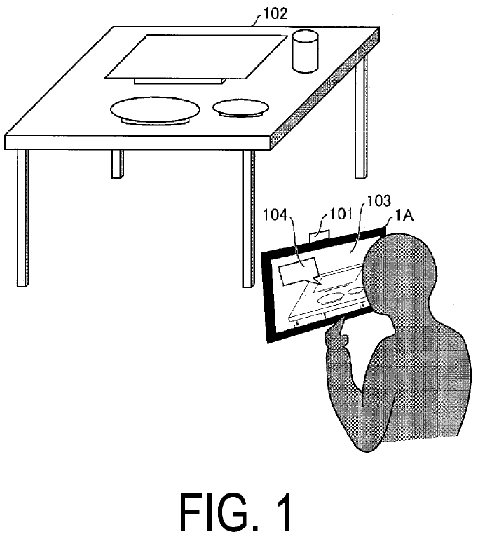

Hereinafter, an embodiment of an image processing device and an image processing program according to the present disclosure will be described with reference to FIGS. 1 to 7.

FIG. 1 is a diagram schematically illustrating an example of a usage aspect of an image processing device 1A according to Embodiment 1.

The image processing device 1A is an image processing device that can superimpose and display visual information on an input image. FIG. 1 illustrates a state in which the image processing device 1A is used to superimpose and display visual information 104 on an input image 103 acquired by capturing an imaging target 102.

In the example illustrated in FIG. 1, the image processing device 1A operates as follows. The image processing device 1A captures the imaging target 102 by a camera 101 for capturing located on a back surface of the image processing device. The image processing device 1A inputs the captured and acquired input image 103, determines a region for displaying the visual information 104, and displays the input image 103 and the visual information 104 in the image processing device 1A.

Note that Embodiment 1 describes a case that the capturing the imaging target 102, the determining the display region of the visual information 104, and the displaying the input image 103 and the visual information 104 are all processed by the identical terminal. However, Embodiment 1 is not limited thereto, and these processes may be performed by a plurality of terminals, or a portion of these processes may be performed by a server.

A type of the visual information 104 is not specifically limited, and examples thereof include character information, graphics, symbols, still images, video, and combinations thereof. Hereinafter, as an example, a case that character information is used as the visual information 104 will be described.

### Functional Block Configuration

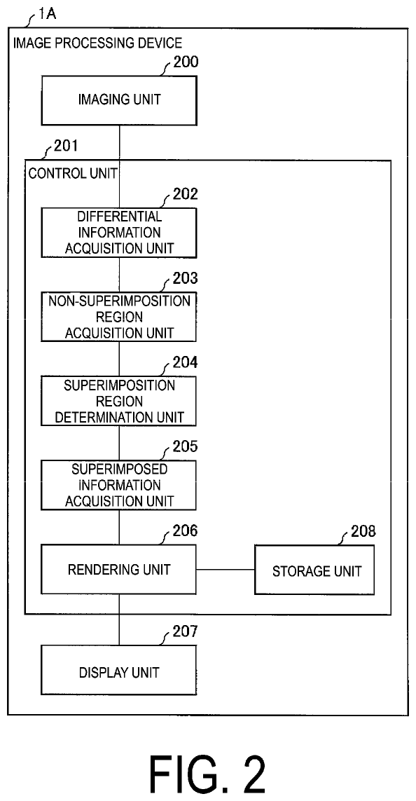

FIG. 2 is a diagram illustrating an example of a functional block configuration of the image processing device 1A according to Embodiment 1.

As illustrated in FIG. 2, the image processing device 1A includes an imaging unit 200, a control unit 201 (image processing unit), and a display unit 207.

The imaging unit 200 includes an optical component for capturing a captured space as an image, and an image pickup device such as a Complementary Metal Oxide Semiconductor (CMOS) and a Charge Coupled Device (CCD), and generates image data of the input image 103 based on an electrical signal obtained by photoelectric conversion in the image pickup device. Note that in an aspect, the imaging unit 200 may output the generated image data as raw data, may perform, on the acquired image data, image processing such as brightness imaging and noise removal by use of an image processing unit (not illustrated) and output the resulting image, or may output both images. The imaging unit 200 outputs the image data and camera parameters such as a focal length at the time of capture to a differential information acquisition unit 202, which will be described later, of the control unit 201. Note that the image data and the camera parameters may be output to a storage unit 208, which will be described later, of the control unit 201.

The control unit 201 includes the differential information acquisition unit 202, a non-superimposition region acquisition unit 203, a superimposition region determination unit 204, a superimposed information acquisition unit 205, a rendering unit 206, and the storage unit 208. The control unit 201 may include one or more processors. To be more specific, the control unit 201 may be realized by a logic circuit (hardware) formed in an integrated circuit (IC chip) or the like, and, for example, may include a Field Programmable Gate Array (FPGA), an Application Specific Integrated Circuit (ASIC), or the like. Alternatively, the control unit 201 may be realized by software using a Central Processing Unit (CPU).

The differential information acquisition unit 202 acquires differential information indicating a difference between pixel values in the image from the input image acquired by the imaging unit 200.

The non-superimposition region acquisition unit 203 acquires a range in which visual information cannot be superimposed on the input image 103 (hereinafter, referred to as a non-superimposition region) with reference to the differential information acquired by the differential information acquisition unit 202. In Embodiment 1, on determining a region where visual information is superimposed, a non-superimposition region is first determined, and then, the region where visual information is superimposed is determined by considering a region excluding the non-superimposition region as a region where visual information can be superimposed. Therefore, the non-superimposition region acquisition unit 203 configured to acquire the non-superimposition region is provided in Embodiment 1.

The superimposition region determination unit 204 makes reference to the non-superimposition region acquired by the non-superimposition region acquisition unit 203 to determine a region (position) where visual information is superimposed on the input image 103.

The superimposed information acquisition unit 205 acquires visual information related to the input image 103. A method for acquiring the visual information related to the input image 103 may be any method, and, for example, a method may be applied in which a marker is associated with the imaging target 102, the imaging unit 200 captures the marker with the imaging target 102, and the visual information associated with the marker is selected, and the like. In an aspect, a data format of the visual information is not specifically limited, and may be a general-purpose data format such as Bitmap and Joint Photographic Experts Group (JPEG), for example, in a case of a still image, or such as Audio Video Interleave (AVI) and Flash Video (FLV), for example, in a case of a moving image, or may be a unique data format. The superimposed information acquisition unit 205 may convert the data format of the acquired visual information. Note that the visual information need not necessarily be related to the image.

The rendering unit 206 generates an image (hereinafter, referred to as a superimposition image) in which the visual information acquired by the superimposed information acquisition unit 205 is superimposed in the region determined by the superimposition region determination unit 204 on the image acquired by the imaging unit 200.

The display unit 207 displays a superimposition image output from the rendering unit 206, a User Interface (UI) for controlling the image processing device A, and the like. In an aspect, the display unit 207 may include a Liquid Crystal Display (LCD), an Organic ElectroLuminescence Display (OELD, Organic EL Display), or the like.

The storage unit 208 stores the visual information acquired by the superimposed information acquisition unit 205 and various pieces of data used in the image processing. In an aspect, the storage unit 208 may include a storage device such as a Random Access Memory (RAM) and a hard disk.

The control unit 201 performs, besides the function in each of functional blocks described above, control of the entire image processing device 1A to perform control on an instruction, control, and data input/output of processing in each function block.

Note that a data bus may be provided to exchange data among the respective units in the control unit 201.

Note that, in an aspect, the image processing device 1A has a configuration including the respective functional blocks described above in one device, as illustrated in FIG. 1. However, Embodiment 1 is not limited thereto, and in other aspects, some functional blocks may be provided with independent housings. For example, in an aspect, a device including the differential information acquisition unit 202, the non-superimposition region acquisition unit 203, the superimposition region determination unit 204, the superimposed information acquisition unit 205, and the rendering unit 206 that render an image to be displayed on the image processing device 1A may be configured using, for example, a personal computer (PC) or the like.

### Configuration of Differential Information Acquisition Unit 202

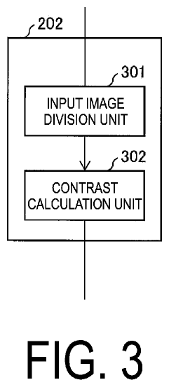

FIG. 3 is a diagram illustrating an example of a functional block configuration of the differential information acquisition unit 202. As illustrated in FIG. 3, the differential information acquisition unit 202 includes an input image division unit 301 and a contrast calculation unit 302.

The input image division unit 301 acquires the input image and divides the input image into a plurality of regions. In an aspect, the input image division unit 301 acquires the input image stored in the storage unit 208.

With reference to respective regions (hereinafter, referred to as divided regions) of the input image divided by the input image division unit 301, the contrast calculation unit 302 calculates a contrast (differential information indicating a difference between pixel values) in each divided region.

### Acquisition Method of Differential Information

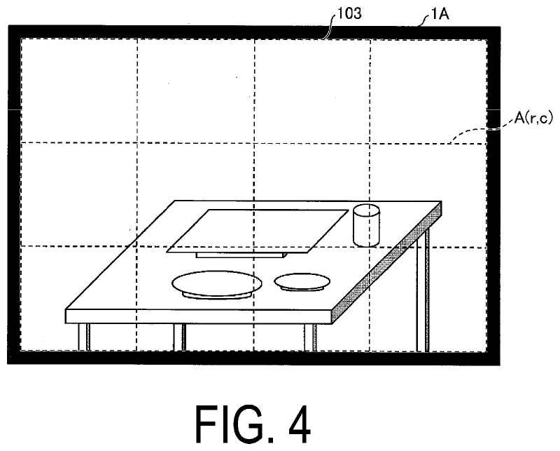

Next, an acquisition method of the differential information by the differential information acquisition unit 202 is described using FIG. 4. FIG. 4 is a diagram illustrating a state in which the contrast is calculated in each divided region of the input image 103.

First, the input image division unit 301 in the differential information acquisition unit 202 divides the input image 103 into a plurality of divided regions. In an example illustrated in FIG. 4, the input image 103 is divided into three rows and four columns, but the number of divisions is not limited thereto, and may be divided into one or more rows and one or more columns. Here, assuming that a divided region at row r and column c in the input image 103 is A(r, c).

Subsequently, the contrast calculation unit 302 in the differential information acquisition unit 202 calculates a contrast in each of the divided regions of the input image 103 divided by the input image division unit 301. Assuming that the contrast in the divided region A(r, c) is V(r, c), V(r, c) can be obtained by, for example, Equation (1) below.

$$\begin{matrix}Equation 1 & \\ V ( r , c ) = \frac{{L}_{max} ( r , c ) - {L}_{min} ( r , c )}{{L}_{max} ( r , c ) + {L}_{min} ( r , c )} & ( 1 )\end{matrix}$$

Here, in Equation (1), Lₘₐₓ(r, c) is a maximum luminance in the divided region A(r, c) and Lₘᵢₙ(r, c) is a minimum luminance in the divided region A(r, c).

Note that in Embodiment 1, it is sufficient that the contrast calculation unit 302 calculates the contrast in the divided region A(r, c), and is not limited to the aspect in which the contrast of a shade is calculated by the luminance (pixel value) as described above. For example, a color contrast may be calculated based on a hue of the input image. Alternatively, the contrast may be calculated based on a chroma.

### Acquisition Method of Non-Superimposition Region

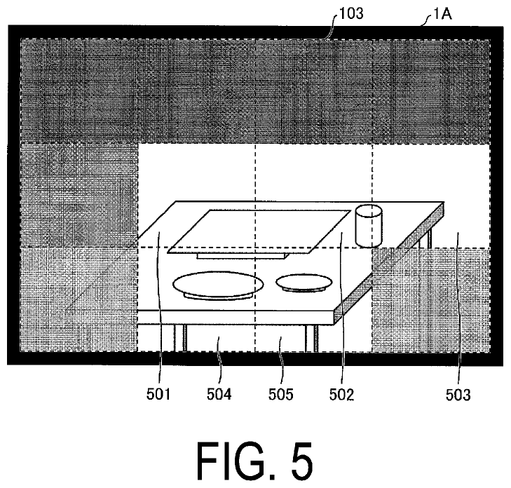

Next, an acquisition method of a non-superimposition region by the non-superimposition region acquisition unit 203 is described using FIG. 5.

FIG. 5 is a diagram illustrating an example of the contrast in each of the divided regions of the input image 103 acquired by the differential information acquisition unit 202. FIG. 5 illustrates that the divided region of color closer to black has a lower contrast and the divided region of color closer to white has a higher contrast.

Thus, the non-superimposition region acquisition unit 203 makes reference to the contrast in the respective divided regions of the input image generated by the differential information acquisition unit 202, and compares the contrast in each divided region of the input image 103 with a contrast threshold Th configured in advance. The contrast threshold Th is stored, for example, in the storage unit 208.

Next, the non-superimposition region acquisition unit 203 determines, by Equation (2) below, a divided region having a contrast equal to or greater than the contrast threshold Th as a non-superimposition region G_{F}, and stores position information of the divided region determined as the non-superimposition region G_{F} within the input image 103 in the storage unit 208.

Equation 2

G_{F}={A(r,c)|1≤r≤R,1≤c≤C,V(r,c)≤Th} (2)

Here, in Equation (2), R is the number of divided rows of the input image, and C is the number of divided columns of the input image.

In the example illustrated in FIG. 5, divided regions 501, 502, 503, 504, and 505 are regions each having a contrast equal to or greater than the contrast threshold Th, and the non-superimposition region acquisition unit 203 determines the divided regions 501, 502, 503, 504, and 505 as the non-superimposition regions G_{F}.

Note that in Embodiment 1, the non-superimposition region acquisition unit 203 may acquire a high contrast divided region as a non-superimposition region in the input image 103, and is not limited to the aspect in which the non-superimposition region is acquired depending on the threshold as described above. For example, the contrasts of the respective divided regions in the input image 103 may be compared, and a prescribed number of divided regions may be acquired as non-superimposition regions in descending order of the contrast. That is, the non-superimposition region acquisition unit 203 may acquire a region having the contrast higher than a prescribed reference as a non-superimposition region, and the reference may be an absolute reference using a threshold or may be a relative reference.

In a case that the non-superimposition region acquisition unit 203 considers that each of the divided regions in the input image 103 has contrast equal to or greater than the contrast threshold Th, the non-superimposition region acquisition unit 203 may determine all of the divided regions in the input image 103 as non-superimposition regions, or determine a prescribed number of divided regions in the input image 103 in descending order of the contrast as non-superimposition regions.

In a case that the non-superimposition region acquisition unit 203 fails to acquire a region having a contrast equal to or greater than the contrast threshold Th, the non-superimposition region acquisition unit 203 may determine that there is no non-superimposition region, or a fixed region such as a divided region located at a center of the input image 103 as a non-superimposition region, for example.

### Determination Method of Superimposition Region

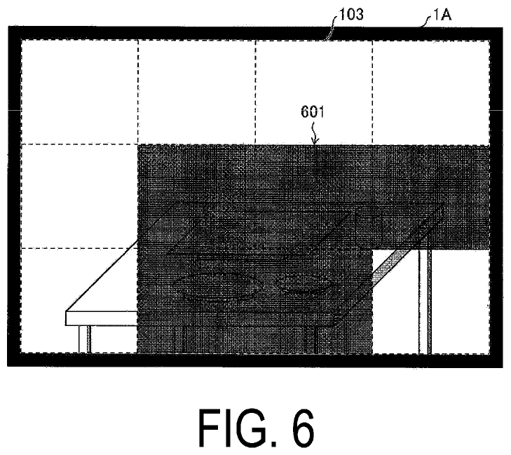

Next, a determination method of a superimposition region by the superimposition region determination unit 204 according to Embodiment 1 is described using FIG. 6. FIG. 6 is a diagram illustrating an example of the non-superimposition region acquired by the non-superimposition region acquisition unit 203. In FIG. 6, a divided region group 601 indicates the non-superimposition regions G_{F}.

First, the superimposition region determination unit 204 acquires position information of the non-superimposition regions G_{F} from the storage unit 208. Next, the superimposition region determination unit 204 determines the superimposition regions from the divided regions other than the non-superimposition regions G_{F}. In an aspect, the superimposition region determination unit 204 first compares the contrasts V(r, c) of the plurality of divided regions A(r, c) belonging to the non-superimposition regions G_{F} with each other, and extracts, from among the plurality of divided regions, a divided region A(r₀, c₀) having a maximum contrast V(r₀, c₀) defined by the following Equation (3).

Equation 3

V(r₀,c₀)=max(V(r,c)) where A(r,c)∈G_{F} (3)

Next, the superimposition region determination unit 204 sequentially searches a divided region A(r₀−1, c₀), a divided region A(r₀, c₀−1), a divided region A(r₀, c₀+1), and a divided region A(r₀+1, c₀) which are adjacent to the divided region A(r₀, c₀). In a case that there is a region not belonging to the non-superimposition regions G_{F}, the superimposition region determination unit 204 determines this region as a superimposition region.

Here, in a case that all the searched divided regions belong to the non-superimposition regions G_{F}, a searched range is changed to divided regions located farther from the divided region A(r₀, c₀), repeating the expansion of the searched range and the search until a divided region not belonging to the non-superimposition regions G_{F} is found.

Note that, in Embodiment 1, it is sufficient that the superimposition region determination unit 204 determines a region other than the non-superimposition region in the input image as a superimposition region, and is not limited to the aspect in which the vicinity of the region having the highest contrast is determined as the superimposition region, as described above. For example, in another aspect, the superimposition region determination unit 204 may determine a region at the outermost edge among the regions other than the non-superimposition region in the input image as a superimposition region, or may determine a region having an area the widest in a case that the superimposition regions are coupled as a superimposition region.

### Flowchart

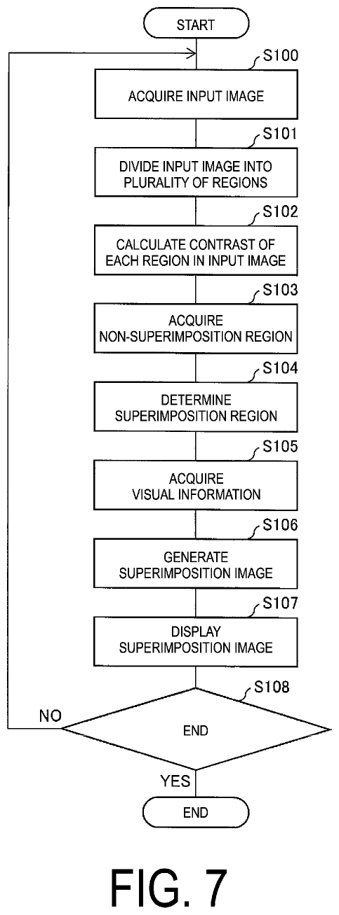

FIG. 7 is a flowchart illustrating an example of an operation performed by the image processing device 1A according to Embodiment 1. With reference to FIG. 7, a process is described in which the image processing device 1A acquires the differential information on the input image 103, makes reference to the acquired differential information to determine a region where the visual information 104 is superimposed on the input image 103, and displays the superimposition image.

Note that, as described above, Embodiment 1 acquires the non-superimposition regions in the input image 103 and makes reference to the acquired non-superimposition region to determine the superimposition region. Hereinafter, the operation by the image processing device 1A will be described based on this aspect.

First, in step S100, an input image from the imaging unit 200 is acquired by the differential information acquisition unit 202. After the acquisition, the process proceeds to step S101.

In step S101, the input image is divided into a plurality of divided regions by the differential information acquisition unit 202. After the division, the process proceeds to step S102.

In step S102, a contrast of each divided region in the input image is calculated by the differential information acquisition unit 202. After the calculation, the process proceeds to step S103.

In step S103, the contrast calculated in step S102 is referenced to detect a non-superimposition region of the input image by the non-superimposition region acquisition unit 203. After the detection, the process proceeds to step S104.

In step S104, the non-superimposition region detected in step S103 is referenced to determine a superimposition region in the input image by the superimposition region determination unit 204. After the determination. the process proceeds to step S105.

In step S105, visual information to be superimposed on the input image is acquired by the superimposed information acquisition unit 205. After the acquisition, the visual information is output to the rendering unit 206 and the process proceeds to step S106.

In step S106, a superimposition image is generated by the rendering unit 206, the superimposition image is obtained by superimposing the visual information acquired in step S105 on the input image 103 in the superimposition region in the input image determined in step S105. After the generation of the superimposition image, the process proceeds to step S107.

In step S107, the superimposition image generated by the rendering unit 206 is acquired to display the superimposition image by the display unit 207.

In step S108, whether to end the display processing is determined by the control unit 201. In a case that the display processing does not end and continues (step S108: NO), the process returns to step S100 and the above-described display processing is repeated. In a case that the display processing ends (step S108: YES), the whole processing ends.

According to the configuration described above, in the image processing device 1A that superimposes the visual information on the input image, a region where the visual information is not superimposed (not display) can be determined in accordance with the differential information on the input image 103.

Note that Embodiment 1 describes an aspect for determining a region (position) where the visual information is superimposed, but this aspect can be alternatively said to be an aspect for determining a region (non-superimposition region) where the visual information is not superimposed based on the acquired differential information.

### Embodiment 2

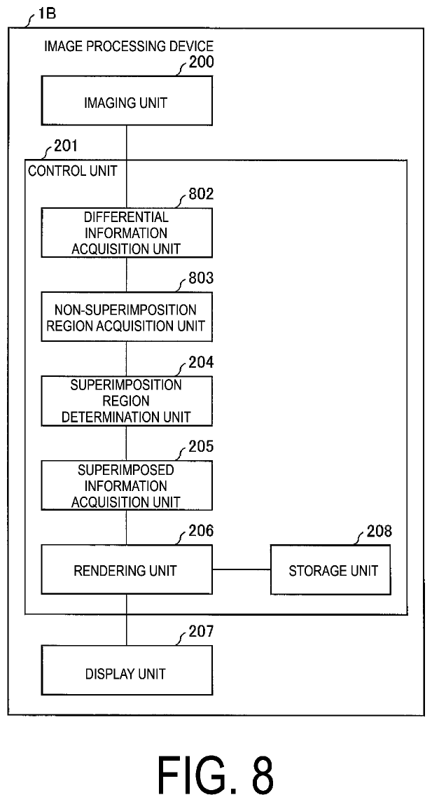

Hereinafter, another embodiment of the present disclosure will be described with reference to FIG. 8 to FIG. 12. For the sake of convenience of description, members having the same functions as the members described above in Embodiment 1 are designated by the same reference signs, and descriptions thereof will be omitted.

FIG. 8 is a diagram illustrating an example of a functional block configuration of an image processing device 1B according to Embodiment 2.

In the image processing device 1B illustrated in FIG. 8, a differential information acquisition unit 802 and a non-superimposition region acquisition unit 803 in a control unit 201 (image processing unit) are different from the differential information acquisition unit 202 and the non-superimposition region acquisition unit 203 in the control unit 201 of the image processing device 1A in Embodiment 1 illustrated in FIG. 2. Except for the above configuration, the image processing device 1B in Embodiment 2 is the same as the image processing device 1A in Embodiment 1.

The differential information acquisition unit 802 acquires a plurality of input images different in a time of capture, and acquires a time difference (differential information) between the input images.

The non-superimposition region acquisition unit 803 acquires the non-superimposition region with reference to the differential information acquired by the differential information acquisition unit 802.

### Configuration of Differential Information Acquisition Unit 802

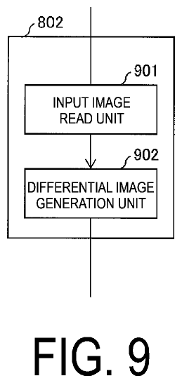

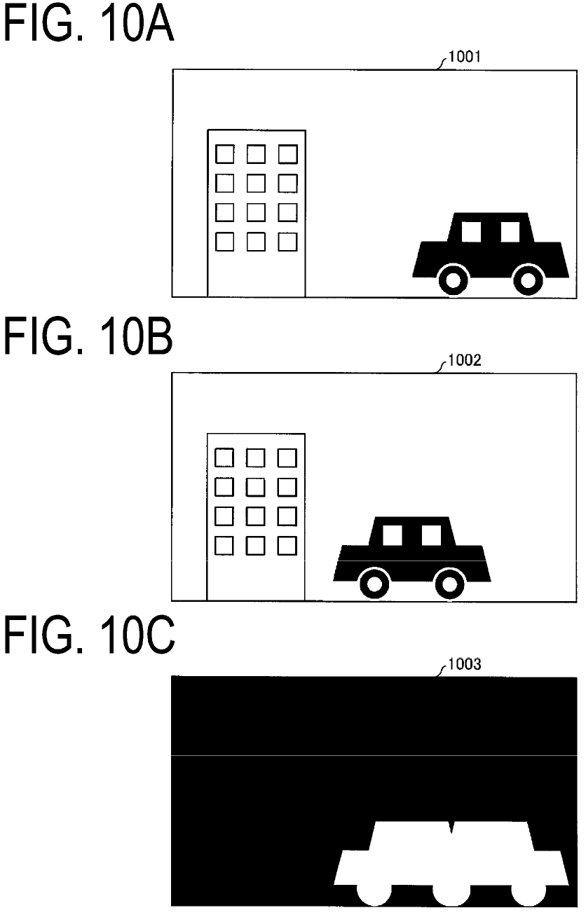

FIG. 9 is a diagram illustrating an example of a functional block configuration of the differential information acquisition unit 802. Each of FIGS. 10A to 10C is a schematic diagram illustrating the differential information acquisition unit 802.

As illustrated in FIG. 9, the differential information acquisition unit 802 includes an input image read unit 901 and a differential image generation unit 902.

The input image read unit 901 acquires, from the storage unit 208 (FIG. 8), two input images different in a time of capture, specifically a first input image 1001 captured at a first time (processing frame t-1) and a second input image 1002 captured at a second time (processing frame t) that is later than the first time, illustrated in FIGS. 10A and 10B, respectively.

The differential image generation unit 902 acquires a differential image 1003 (differential information) from the first input image 1001 and the second input image 1002.

Here, assuming that a pixel (m, n) of the input image at the processing frame t is Iₜ(m, n) and a pixel value of the pixel (m, n) of the differential image 1003 is D(m, n), the differential image 1003 can be calculated by Equation (4) below;

Equation 4

D(m,n)=|Iₜ(m,n)−Iₜ₋₁(m,n) (4)

Note that the pixel value of the pixel (m, n) of the differential image 1003 may be a luminance value in an aspect, but is not limited thereto, and the pixel value may be any of RGB, or may be chroma, hue, or the like.

By use of the calculated differential image 1003, a location where there is a large fluctuation in the pixel value can be detected. Here, in Embodiment 2, it is assumed that the same capture range is taken at the different times of capture, and in such a premise, the location where there is a large fluctuation in the pixel value depending on the time of capture represents a location where an imaging object appears in a real space. Such an imaging object includes a moving object. In Embodiment 2, the moving object is considered an imaging object to be recognized by a user. In other words, in Embodiment 2, a presence or absence and position of the moving object are detected by observing a temporal variation in the pixel values in the input image such that the visual information is not superimposed on these positions.

The differential image 1003 may be stored in the storage unit 208 without change, or may be binarized by a threshold ThD and then stored in the storage unit 208.

### Acquisition Method of Non-Superimposition Region

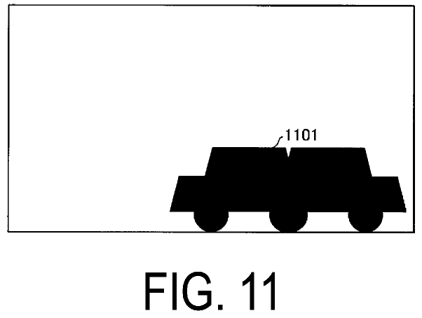

The non-superimposition region acquisition unit 803 makes reference to the differential image 1003 generated by the differential image generation unit 902 in the differential information acquisition unit 802, and sets a pixel of the differential image 1003 having a pixel value greater than or equal to a threshold as a non-superimposition region. In the example of FIG. 11, a region 1101 is a non-superimposition region. As described above, the non-superimposition region acquisition unit 803 sets a region in the input image where the change in time is greater than a prescribed reference as the non-superimposition region.

Movement direction information of the non-superimposition region may be used to predict a region likely to be the non-superimposition region in the next processing frame and the predicted region may be also set as the non-superimposition region. The movement direction information can be obtained by a well-known algorithm such as linear prediction.

### Flowchart

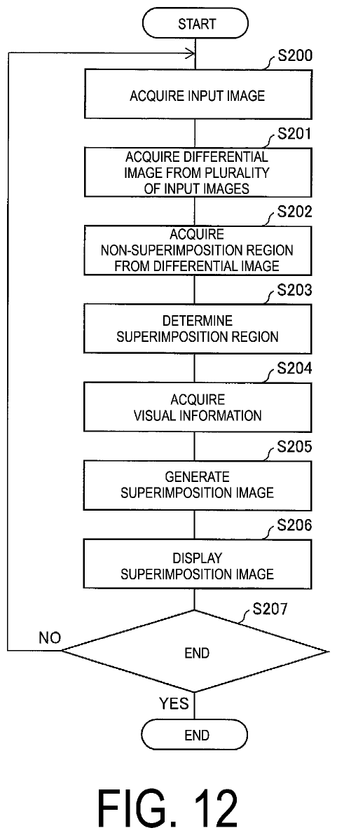

FIG. 12 is a flowchart illustrating an example of an operation performed by the image processing device 1B according to Embodiment 2. With reference to FIG. 12, a process is described in which the image processing device 1B acquires the differential information on the input image 103, makes reference to the acquired differential information to determine a region where the visual information 104 is superimposed on the input image 103, and displays the superimposition image.

Note that, as is Embodiment 1 described above, Embodiment 2 also acquires the non-superimposition regions in the input image 103 and makes reference to the acquired non-superimposition region to determine the superimposition region.

First, in step S200, a plurality of input images are acquired from the imaging unit 200 by the differential information acquisition unit 802. After the acquisition, the process proceeds to step S201.

In step S201, a differential image is acquired from the plurality of input images by the differential information acquisition unit 802. After the acquisition, the process proceeds to step S202.

In step S202, the differential image acquired in step S201 is referenced to acquire a non-superimposition region by the non-superimposition region acquisition unit 803. After the acquisition, the process proceeds to step S203.

In step S203, the non-superimposition region acquired in step S202 is referenced to determine a superimposition region in the input image by the superimposition region determination unit 204. After the determination, the process proceeds to step S204.

In step S204, visual information to be superimposed on the input image is acquired by the superimposed information acquisition unit 205. After the acquisition, the process proceeds to step S205.

In step S205, a superimposition image is generated by the rendering unit 206, the superimposition image is obtained by superimposing the visual information acquired in step S205 on the input image in the superimposition region determined in step S203. After the generation, the process proceeds to step S206.

In step S206, the superimposition image generated by the rendering unit 206 is acquired to display the superimposition image by the display unit 207.

In step S207, whether to end the display processing is determined by the control unit 201. In a case that the display processing does not end and continues (step S207: NO), the process returns to step S200 and the above-described display processing is repeated. In a case that the display processing ends (step S207: YES), the whole processing ends.

According to the configuration described above, in the image processing device 1B that superimposes the visual information on the input image, a region where the visual information is not superimposed (not display) can be determined in accordance with the differential information on the input image 103.

Further, according to Embodiment 2, a region where the moving object is displayed is set as the non-superimposition region such that the visual information is not displayed in that region. This can ensure visibility for the user with respect to the moving object. In a case that the visual information is superimposed in the region where the moving object is displayed, the user may not be able to view the moving object and may be dangerous. However, according to the configuration of Embodiment 2, such a risk can be avoided.

Note that Embodiment 2 describes also an aspect for determining a region (position) where the visual information is superimposed as in Embodiment 1, but this aspect can be alternatively said to be an aspect for determining a region (non-superimposition region) where the visual information is not superimposed based on the acquired differential information.

### Embodiment 3

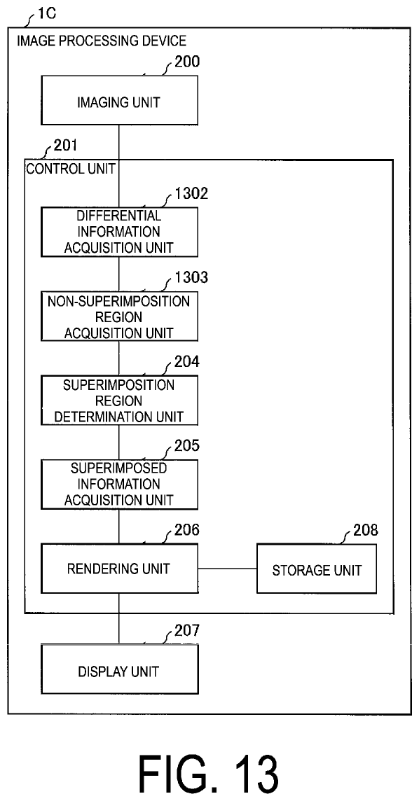

Hereinafter, another embodiment of the present disclosure will be described with reference to FIG. 13 to FIG. 15. For the sake of convenience of description, members having the same functions as the members described above in Embodiment 2 are designated by the same reference signs, and descriptions thereof will be omitted.

FIG. 13 is a diagram illustrating an example of a functional block configuration of an image processing device 1C according to Embodiment 3.

In the image processing device 1C illustrated in FIG. 13, a differential information acquisition unit 1302 and a non-superimposition region acquisition unit 1303 in the control unit 201 (image processing unit) are different from the differential information acquisition unit 802 and the non-superimposition region acquisition unit 803 in the control unit 201 of the image processing device 1B in Embodiment 2 illustrated in FIG. 8. Except for the above configuration, the image processing device 1C in Embodiment 3 is the same as the image processing device 1B in Embodiment 2.

In Embodiment 3, in order to improve the visibility of the visual information, the non-superimposition region and the superimposition region are determined such that the position of the superimposed visual information does not vary greatly. To achieve this, Embodiment 3 includes a step of acquiring a focus position (focal position) of the input image differently from Embodiment 2. A specific description is as follows.

The differential information acquisition unit 1302 acquires a plurality of input images different in a time of capture and focus positions of the input images.

The non-superimposition region acquisition unit 1303 makes reference to a time difference between the input images and a time difference between the focus positions to acquire a non-superimposition region.

### Configuration of Differential Information Acquisition Unit 1302

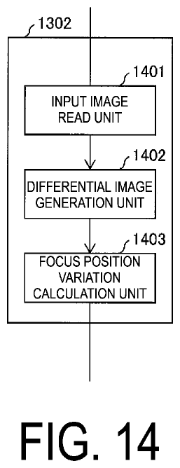

FIG. 14 is a diagram illustrating an example of a functional block configuration of the differential information acquisition unit 1302.

As illustrated in FIG. 14, the differential information acquisition unit 1302 includes an input image read unit 1401, a differential image generation unit 1402, and a focus position variation calculation unit 1403.

The input image read unit 1401 acquires, from the storage unit 208, a first input image 1001 and a second input image 1002 different from each other in a time of capture, a focus position of the first input image 1001, and a focus position of the second input image 1002. Here, as an aspect of an acquisition method of a focus position, a method may be used in which a contrast is calculated for each pixel to acquire, as a focus position, a position of a contrast higher than a preset threshold, or a position where a contrast is the highest by comparing contrasts in the image. Note that the acquisition method is not limited to this example.

The differential image generation unit 1402 acquires a differential image 1003 from the first input image 1001 and the second input image 1002, similar to the differential image generation unit 902 (FIG. 9) in Embodiment 2.

The focus position variation calculation unit 1403 calculates a displacement of the focus position with reference to the focus position of the first input image 1001 and the focus position of the second input image 1002 acquired by the input image read unit 1401.

### Acquisition Method of Non-Superimposition Region

The non-superimposition region acquisition unit 1303 makes reference to the displacement of the focus position, and in a case that the displacement of the focus position is greater than or equal to a prescribed reference (for example, greater than or equal to a threshold ThF), the non-superimposition region acquisition unit 1303 makes reference to the differential image 1003 and sets pixels of the differential image 1003 having pixel values greater than or equal to the threshold as a non-superimposition region.

In a case that the displacement of the focus position is smaller than or equal to a prescribed reference (for example, smaller than the threshold ThF), the non-superimposition region acquisition unit 1303 maintains the non-superimposition region. This allows the image processing device 1C not to change the position where the visual information is superimposed in a case that the variation in the focus position is smaller than a prescribed reference.

### Flowchart

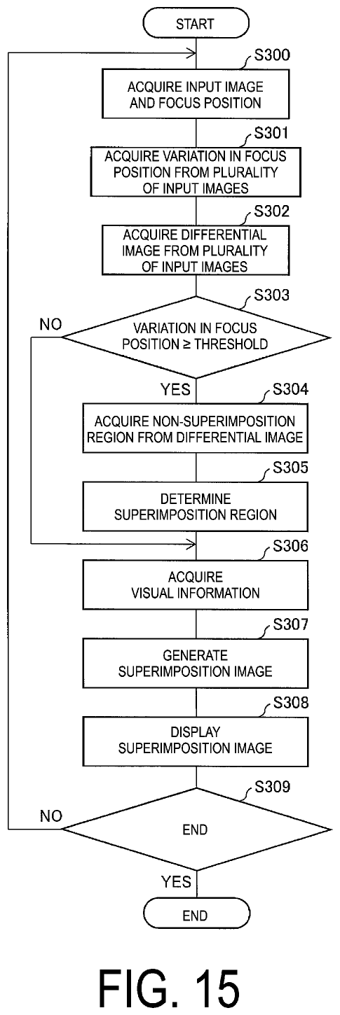

FIG. 15 is a flowchart illustrating an example of an operation performed by the image processing device 1C according to Embodiment 3.

First, in step S300, a plurality of input image from the imaging unit 200 are acquired by the differential information acquisition unit 1302. After the acquisition, the process proceeds to step S301.

In step S301, a displacement of a focus position is acquired from the plurality of input images by the focus position variation calculation unit 1403 in the differential information acquisition unit 1302. After the acquisition, the process proceeds to step S302.

In step S302, a differential image is acquired from the plurality of input images by the differential image generation unit 1402 in the differential information acquisition unit 1302. After the acquisition, the process proceeds to step S303.

In step S303, whether or not the displacement of the focus position acquired in step S301 by the focus position variation calculation unit 1403 is greater than or equal to a threshold is determined by the non-superimposition region acquisition unit 1303. In a case that, as a result of the determination, the displacement of the focus position is greater than or equal to the threshold (step S303: YES), the process proceeds to step S304.

In step S304, a non-superimposition region is acquired from the differential image by the non-superimposition region acquisition unit 1303. After the acquisition, the process proceeds to step S305.

In step S305, the non-superimposition region acquired in step S304 is referenced to determine a superimposition region in the input image by the superimposition region determination unit 204. After the determination. the process proceeds to step S306.

On the other hand, as a result of the determination in step S303, in a case that the displacement of the focus position is smaller than the threshold (step S303: NO), the process proceeds to step S306 without changing the non-superimposition region and the superimposition region.

In step S306, visual information to be superimposed on the input image is acquired by the superimposed information acquisition unit 205. After the acquisition, the process proceeds to step S307.

In step S307, a superimposition image is generated by the rendering unit 206, the superimposition image is obtained by superimposing the visual information acquired in step S306 on the input image in the superimposition region determined in step S305. After the generation, the process proceeds to step S308.

In step S308, the superimposition image generated by the rendering unit 206 is acquired to display the superimposition image by the display unit 207.

In step S309, whether to end the display processing is determined by the control unit 201. In a case that the display processing does not end and continues (step S309: NO), the process returns to step S300 and the above-described display processing is repeated. In a case that the display processing ends (step S309: YES), the whole processing ends.

Note that in Embodiment 3, in the case that the displacement of the focus position is greater than or equal to the threshold, the non-superimposition region is determined as in Embodiment 2 based on the differential image generated using two input images different in the time of capture in step S304, but the present invention is not limited thereto. For example, an aspect may be adopted in which in the case that the displacement of the focus position is greater than or equal to the threshold, the determination of the non-superimposition region may be made with reference to the contrast (differential information indicating a difference between the pixel values) described in Embodiment 1.

As described above, according to Embodiment 3, in the case that the displacement of the focus position is smaller than the threshold, a superimposed position of the visual information is not changed. As a result, in a case that the focus position does not change and the user's line of sight does not move, such as in a case of adjusting zoom, it is possible to suppress a reduction in the visibility of the visual information caused by the superimposed position of the visual information moving.

### Embodiment 4

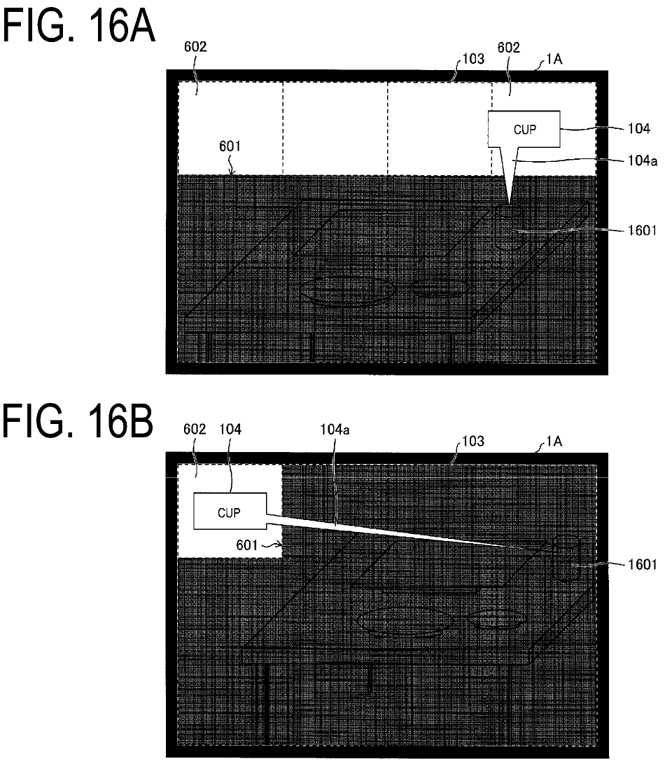

A display mode of the visual information 104 in the image processing device 1A illustrated in FIG. 1 according to Embodiment 1 described above is further described below based on FIG. 16A to FIG. 18. For the sake of convenience of description, members having the same functions as the members described above in Embodiment 1 are designated by the same reference signs, and descriptions thereof will be omitted.

FIGS. 16A and 16B illustrate one form of the display mode of the visual information 104. In FIGS. 16A and 16B, regarding a cup 1601, which is an imaging object (a part) in the input image 103, visual information 104 “cup” and a balloon image 104a (additional image) associated therewith are superimposed in a superimposition region 602. The balloon image 104a has a shape stood out from the cup 1601 in the input image 103, and coupling of the cup 1601 and the visual information 104 indicates that both are associated with each other.

A difference between FIG. 16A and FIG. 16B is in a range of the superimposition region 602. In an aspect illustrated in FIG. 16A, the superimposition region 602 is near the cup 1601 in the input image 103, and the visual information 104 and the balloon image 104a are superimposed at a position near the cup 1601. On the other hand, in an aspect illustrated in FIG. 16B, the superimposition region 602 is on the left end of the input image 103, where is a position relatively far from the cup 1601 presented on the right end in the input image 103. As such, the visual information 104 and the balloon image 104a are superimposed in the superimposition region 602 on the left end in the input image 103, but the balloon image 104a has a shape stood out from the cup 1601 like the aspect illustrated in FIG. 16A, where the shape couples the cup 1601 and the visual information 104 with each other that are apart positioned on the left and right ends. Thus, the user can determine what the superimposed visual information 104 is related to.

Even in a case that a captured range is changed from the state illustrated in FIG. 16A to the state illustrated in FIG. 16B to change the superimposed position of the visual information 104, in a case that the shape of the balloon image 104a changes with the change of the captured range, the visual information 104 can cause the user to resolve the failure that the cup 1601 is not visible and to view both the visual information 104 and the cup 1601.

That is, in an aspect, the shape of the balloon image 104a is determined based on a coordinate position at which the visual information 104 is superimposed and a coordinate position of an imaging object (a part) associated with the visual information 104 in the input image 103.

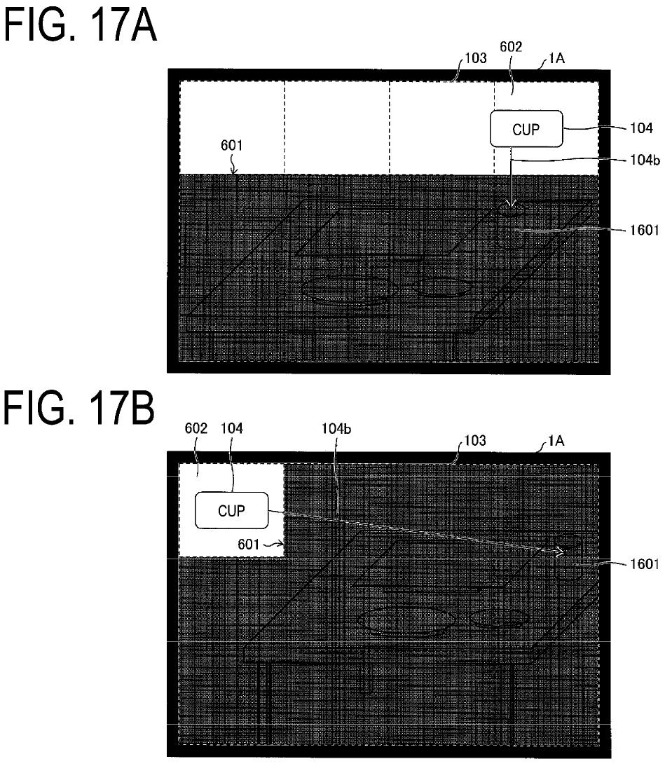

In an aspect illustrated in FIGS. 17A and 17B, similar to FIGS. 16A and 16B, based on the coordinate position of the superimposition region 602 where the visual information 104 is superimposed and the coordinate position of the cup 1601, a direction and length (shape) of an indicating line 104b (additional image) are determined, the indicating line 104b connecting the visual information 104 with the cup 1601 that is the imaging object associated with the visual information 104 in the input image 103.

Note that, herein, a change in the shape of the indicating line 104b includes a case that only the length of the indicating line 104b changes. That is, in an aspect, the shape of the indicating line 104b is determined based on the coordinate position at which the visual information 104 is superimposed and the coordinate position of the imaging object (a part) associated with the visual information 104 in the input image 103.

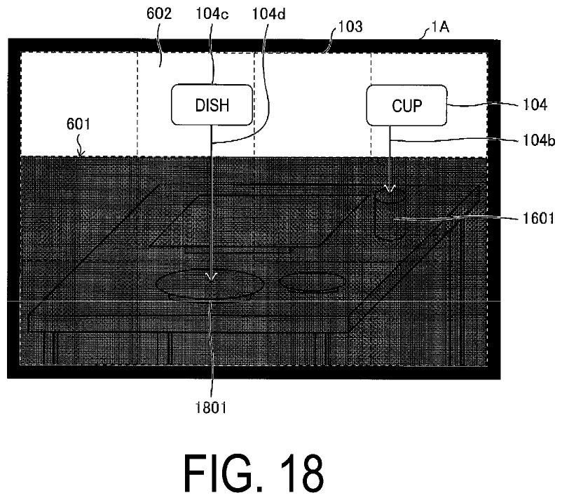

An aspect illustrated in FIG. 18 illustrates a case that different pieces of visual information are superimposed in a plurality of different parts in the input image 103. FIG. 18 illustrates, as examples, two parts in the input image 103, a cup 1601 and a dish 1801. Then, visual information 104 “cup” for the cup 1601 and visual information 104c “dish” for the dish 1801 are superimposed on the input image 103. In this aspect, the visual information 104 “cup” is superimposed at a position closer to the cup 1601 than the visual information 104c “dish”. Similarly, the visual information 104c “dish” is superimposed at a position closer to the dish 1801 than the visual information 104 “cup”.

Furthermore, in the aspect illustrated in FIG. 18, an indicating line 104b (additional image) connecting the visual information 104 “cup” with the cup 1601 is superimposed on the input image 103. Similarly, an indicating line 104d (additional image) connecting the visual information 104c “dish” with the dish 1801 is superimposed on the input image 103. In the aspect illustrated in FIG. 18, the visual information 104 “cup” is superimposed at the position closer to the cup 1601, and the visual information 104c “dish” is superimposed at the position closer to the dish 1801 so that the two indicating lines 104b and 104d are configured not to intersect.

That is, in an aspect, by arranging the visual information and the imaging object (part) associated with the visual information to be adjacent to each other in the image, even in a case that a plurality of kinds of visual information are displayed in a superimposed manner, each piece of visual information can be visually recognized without confusion.

### Embodiment 5

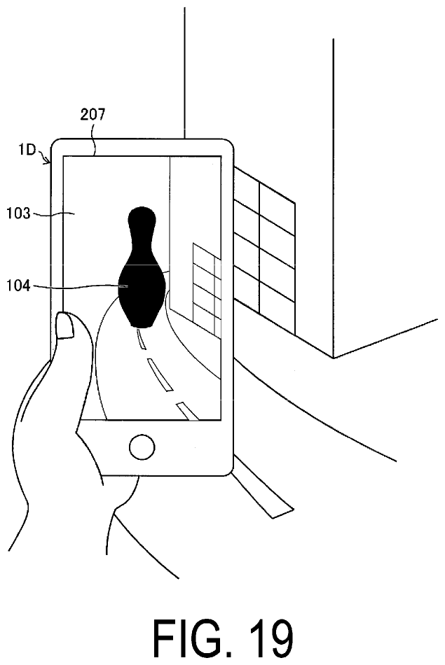

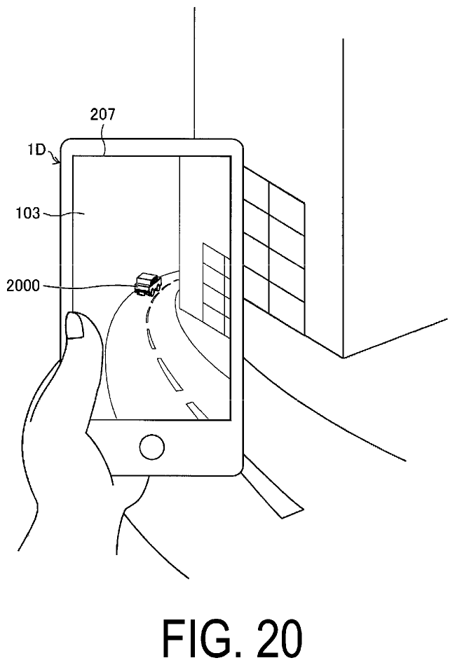

Hereinafter, another embodiment of the present disclosure will be described with reference to FIG. 19 to FIG. 20. For the sake of convenience of description, members having the same functions as the members described above in Embodiment 2 are designated by the same reference signs, and descriptions thereof will be omitted.

FIG. 19 is a diagram illustrating an example of a usage mode of an image processing device 1D according to Embodiment 5. Although already described in Embodiment 2 above, as an aspect of the present disclosure, an input image can be used to detect a moving object on a real space, and to not superimpose visual information on a position of the detected moving object. This is described in detail in Embodiment 5.

The image processing device 1D according to Embodiment 5 differs from the image processing device 1B according to Embodiment 2 in that the control unit 201 detects a moving object from an input image acquired by a camera, and switches whether to superimpose visual information depending on a position of the detected moving object.

Specifically, the control unit 201 in the image processing device 1D according to Embodiment 5 is configured to switch the visual information not to be superimposed in a case that the position of the detected moving object is within a region where the visual information is superimposed. This allows the user to recognize the moving object hidden by the visual information.

On the display unit 207 in the image processing device 1D illustrated in FIG. 19, an image obtained by capturing, in real time, a road that extends in a direction from the front to the back of a screen is displayed as the input image 103. In the display unit 207, a superimposition region is configured near a center of the input image 103, and the visual information 104 shaped into a bowling pin is displayed in a superimposed manner in the superimposition region.

In an aspect, in a case that a vehicle (moving object) appears on the road from the far side in the screen and moves in a state illustrated in FIG. 19, the moving vehicle is detected using the input image. Then, in response to the detection result, a process is performed in which the bowling pin-shaped visual information 104 that is displayed in a superimposed manner is made to be not superimposed. Specifically, in response to receiving the detection result that the moving vehicle is detected, the superimposition region configured near the center of the input image 103 is switched to the non-superimposition region. With this configuration, the bowling pin-shaped visual information 104 that is displayed in a superimposed manner on the superimposition region configured near the center of the input image 103 disappears. The bowling pin-shaped visual information 104 may completely disappear from the input image 103 displayed on the display unit 207, or the superimposed position thereof may be shifted to another superimposition region.

In short, in Embodiment 5, a process is performed in which the region already configured as the superimposition region is switched to the non-superimposition region in accordance with the position of the detected moving object.

The vehicle appearing and moving can be detected by acquiring the time difference (differential information) between the input images 103 as described in Embodiment 2. At this time, the position of the appearing vehicle in the input image(s) can also be identified.

FIG. 20 illustrates an example of the display unit 207 in the case that the vehicle appearing is detected. In FIG. 20, a vehicle 2000 is presented in the input image 103 displayed on the display unit 207, and the bowling pin-shaped visual information 104 that is displayed in a superimposed manner in FIG. 19 is not superimposed.

According to Embodiment 5, it is possible to detect the moving object and switch whether or not the visual information is superimposed. As illustrated in FIG. 19 and FIG. 20, the visual information 104 that has already been displayed in a superimposed manner can be made non-superimposed due to the detection of the moving object.

Thus, in a case that the image processing device 1D is used in the saturation as illustrated in FIG. 19 and FIG. 20, the user can recognize the vehicle appearing, and therefore, for example, in a case that the user enters a road, or is in close proximity to the road for capturing, the user can awake to the vehicle and take refuge, and the like, preventing accidents from occurring.

In particular, in a case that the position of the detected vehicle 2000 is within a region where the bowling pin-shaped visual information 104 is superimposed, and a movement direction of the vehicle 2000 is a direction toward the front of the screen of the input image 103, it is preferable to configure such that the bowling pin-shaped visual information 104 is switched not to be superimposed. The movement direction information of the vehicle 2000 can be obtained by linear prediction as described in Embodiment 2. Such a configuration can ensure the visibility for the user with respect to the moving object that is hidden by the visual information and moves in a direction toward the user.

### Embodiment 6

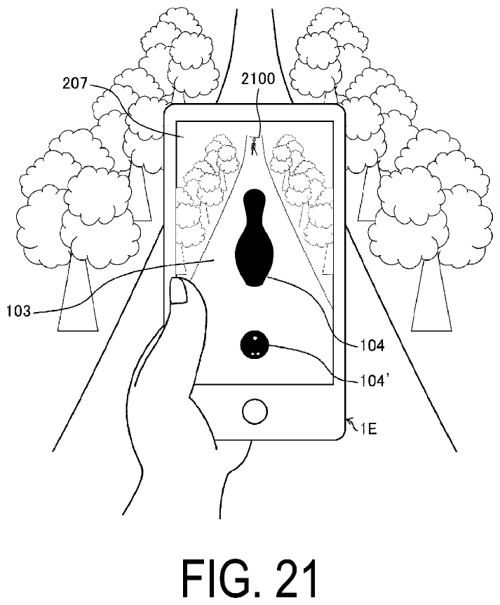

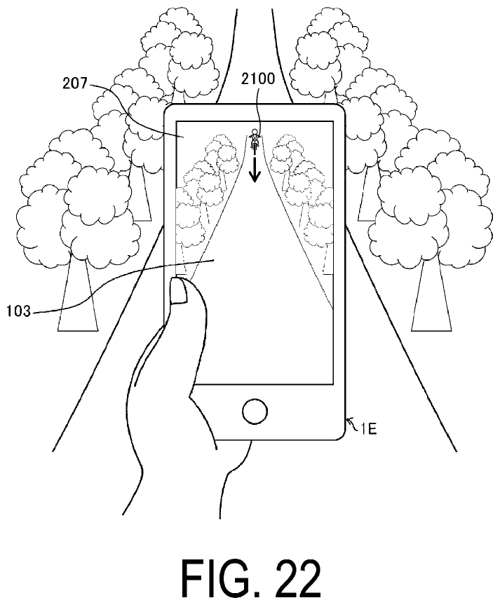

Hereinafter, another embodiment of the present disclosure will be described with reference to FIG. 21 to FIG. 22. For the sake of convenience of description, members having the same functions as the members described above in Embodiment 5 are designated by the same reference signs, and descriptions thereof will be omitted.

In Embodiment 5 described above, a process is performed in which the region already configured as the superimposition region is switched to the non-superimposition region in accordance with the position of the detected moving object. In contrast, in Embodiment 6, a process is performed in which the visual information is switched not to be superimposed in accordance with the movement direction of the detected moving object.

FIG. 21 is a diagram illustrating an example of a usage mode of an image processing device 1E according to Embodiment 6. In FIG. 21, a user gripping the image processing device 1E captures a road extending from a front side to a far side of the paper sheet. In the display unit 207, an input image 103 which is captured with the road and an area surrounding the road being a capture range, and visual information 104 shaped into a bowling pin and visual information 104′ shaped into a bowling ball which are respectively displayed in a superimposed manner at positions near and below the center of the input image 103 are displayed on the display unit 207. In the input image 103 in FIG. 21, a bicycle 2100 placed on a tip of the road is captured.

In Embodiment 6, in a case that the bicycle 2100 moves, the control unit 201 in the image processing device 1E detects this movement by using an input image, and in a case that the movement direction of the detected bicycle 2100 (moving object) is a direction toward the front of the screen of the input image 103, the bowling pin-shaped visual information 104 and the bowling ball-shaped visual information 104′ are switched not to be superimposed.

FIG. 22 illustrates a state in which the input image 103 is displayed on the display unit 207, the input image 103 illustrating a state in which the bicycle 2100 is moving toward the front of the screen of the input image 103 (a direction indicated by an arrow in FIG. 22).

In a case that the control unit 201 in the image processing device 1E detects, based on the input image 103, that the bicycle 2100 is moving toward the front of the screen of the input image 103 as illustrated in FIG. 22, the control unit 201 causes the bowling pin-shaped visual information 104 and the bowling ball-shaped visual information 104′ displayed in a superimposed manner not to be superimposed each other.

On the other hand, in a case that the movement direction of the detected bicycle 2100 (moving object) is in a direction toward a crosswise direction of the input image 103, the control unit 201 in the image processing device 1E maintains the bowling pin-shaped visual information 104 and the bowling ball-shaped visual information 104′ in a superimposed state.

The movement and the movement direction of the bicycle 2100 can be detected by acquiring the time difference (differential information) between the input images 103 as described in Embodiment 2.

According to Embodiment 6, in a case that the image processing device 1E is used in the saturation as illustrated in FIG. 21 and FIG. 22, the user can recognize a moving object moving in a direction toward the user, and it is possible to prevent accidents from occurring.

### Implementation Examples by Software

The control unit 201 in each of the image processing devices 1A to 1E may be implemented by a logic circuit (hardware) formed as an integrated circuit (IC chip) or the like, or by software using a Central Processing Unit (CPU).

In the latter case, the control unit 201 includes a CPU to execute an instruction of a program that is software implementing the functions, a Read Only Memory (ROM) or a storage device (these are referred to as “recording media”) in which the program and various data are stored to be readable by a computer (or CPU), a Random Access Memory (RAM) in which the program is deployed, and the like. The computer (or CPU) reads from the recording medium and performs the program to achieve the object of the present disclosure. As the above-described recording medium, a “non-transitory tangible medium” such as a tape, a disk, a card, a semiconductor memory, and a programmable logic circuit can be used. The above-described program may be supplied to the above-described computer via an arbitrary transmission medium (such as a communication network and a broadcast wave) capable of transmitting the program. Note that an aspect of the present disclosure may also be implemented in a form of a data signal embedded in a carrier wave in which the program is embodied by electronic transmission.

### Supplement

An image processing devices 1A, 1B, or 1C according to Aspect 1 of the present disclosure includes an image processing unit (a control unit 201) configured to superimpose visual information 104 on an input image 103, wherein the image processing unit (the control unit 201) determines a position (a superimposition region) at which the visual information 104 is to be superimposed based on differential information for indicating at least one of a difference (a contrast) between pixel values in the input image 103 and a difference (a differential image 1003) between the input images 103.

According to the above-described configuration, it is possible to provide the image processing device that determines, by image processing, the position where the visual information is displayed in a superimposed manner.

Specifically, the position where the visual information is displayed in a superimposed manner on the input image is determined based on the differential information on the input image.

In the image processing device 1A according to Aspect 2 of the present disclosure, in above Aspect 1, the differential information may include information for indicating a contrast of the input image, and the image processing unit (the control unit 201) may determine the position at which the visual information 104 is to be superimposed such that the visual information 104 is not superimposed in a region having the contrast higher than a prescribed criterion.

A location having a high contrast in the input image is considered to be a location for the user to want to view or to be viewed by the user. Therefore, according to the above-described configuration, other than the above-described location is determined as the position where the visual information is superimposed such that the visual information is not superimposed on the above-described location. This allows the user to comfortably view the input image including the above-described location and the visual information superimposed on other than the above-described location.

In the image processing device 1B or 1C according to Aspect 3 of the present disclosure, in above Aspect 1 or 2, the differential information may include information for indicating a change in time between the input images (a first input image 1001 and a second input image 1002), and the image processing unit (the control unit 201) may determine the position at which the visual information 104 is to be superimposed such that the visual information 104 is not superimposed in a region having the change in time larger than a prescribed criterion.

The region having the larger change in time between the input images which are different in a time of capture can be considered to include some significant information. For example, a moving real object may be being captured. Such a region can be said to be a region to be viewed by the user. Therefore, according to the above-described configuration, the visual information is configured not to be superimposed on such a Gaze region. This allows the user to view the information to be viewed in the input image and also view the superimposed visual information.

In the image processing device 1C according to Aspect 4 of the present disclosure, in above Aspects 1 to 3, the differential information includes information for indicating a displacement of a focal position (a focus position) of the input image, and the image processing unit does not change the position at which the visual information 104 is to be superimposed in a case that the displacement of the focal position (the focus position) is smaller than a prescribed criterion.

According to the above-described configuration, in a case that the focus position does not change and the user's line of sight does not move, such as in a case of adjusting zoom, it is possible to suppress a reduction in the visibility of the visual information caused by the superimposed position of the visual information moving.

The image processing devices 1A, 1B, or 1C according to Aspect 5 of the present disclosure, in above Aspect 1 to 4, superimposes an additional image (a balloon image 104a, or an indicating line 104b or 104d) associated with the visual information on the input image 103, and changes a shape of the additional image (the balloon image 104a, or the indicating line 104b or 104d) depending on the position, which has been determined, for superimposing the visual information.

According to the above-described configuration, the user can easily recognize the association between the imaging object and the visual information 104 superimposed thereon.

In the image processing device 1A, 1B or 1C according to Aspect 6 of the present disclosure, in above Aspects 1 to 5, the visual information 104 or 104c is associated with a specific part (a cup 1601, or a dish 1801) in the input image, and the image processing unit (the control unit 201) changes the shape of the additional image (the balloon image 104a, or the indicating line 104b or 104d) into a shape that connects the specific part (the cup 1601, or the dish 1801) with the visual information 104 or 104c.

According to the above-described configuration, the user can more easily recognize the association between the imaging object and the visual information 104 superimposed thereon.

In the image processing device 1A, 1B or 1C according to Aspect 7 of the present disclosure, in above Aspects 1 to 6, the image processing unit (the control unit 201) superimposes a plurality of pieces of the visual information (the indicating lines 104b and 104d) on the input image 103, the plurality of pieces of the visual information (the indicating lines 104b and 104d) are respectively associated with parts (the cup 1601 and the dish 1801) that are different from each other in the input image 103, and the image processing unit (the control unit 201) determines the positions at which the plurality of pieces of the visual information are to be superimposed respectively such that the position at which one of the plurality of pieces of the visual information (the indicating line 104b or 104d) is closer to the part associated with the one of the plurality of pieces of the visual information rather than the part associated with another one of the plurality of pieces of the visual information.

According to the above-described configuration, even in a case that a plurality of kinds of visual information are displayed in a superimposed manner, each piece of visual information can be visually recognized without confusion.

An image processing device 1A, 1B or 1C according to Aspect 8 of the present disclosure includes an image processing unit (a control unit 201) configured to superimpose visual information 104 on an input image 103, wherein the image processing unit (the control unit 201) determines a range (a non-superimposition region) in which the visual information is not to be superimposed based on differential information for indicating at least one of a difference between pixel values in the input image 103 and a difference between the input images 103.

According to the above-described configuration, it is possible to provide the image processing device that determines, by image processing, the range in which the visual information is not displayed in a superimposed manner.

Specifically, the range in which the visual information is not displayed in a superimposed manner on the input image can be determined based on the differential information on the input image. This makes it possible to determine a region excluding the determined range in which nothing is displayed in a superimposed manner as a region where the visual information can be displayed in a superimposed manner to display the visual information in a superimposed manner on the region.

An image processing device 1B or 1D according to Aspect 9 of the present disclosure includes an image processing unit (a control unit 201) configured to superimpose visual information 104 on an input image 103, wherein the image processing unit (the control unit 201) detects a moving object (a vehicle 2000) from the input image 103, and performs switching whether to superimpose the visual information (bowling pin-shaped visual information 104) based on at least one of a position and a movement direction of the moving object detected (the vehicle 2000).

According to the above-described configuration, the visibility for the user with respect to the moving object can be ensured.

The image processing device 1D according to Aspect 10 of the present disclosure, in above Aspect 9, performs the switching not to superimpose the visual information (the bowling pin-shaped visual information 104) in a case that the position of the moving object detected (the vehicle 2000) is within a region where the visual information is superimposed.

According to the above-described configuration, the visibility for the user with respect to the moving object that is hidden by the visual information can be ensured.

The image processing device 1D according to Aspect 11 of the present disclosure, in above Aspect 9, performs the switching not to superimpose the visual information (the bowling pin-shaped visual information 104) in a case that the position of the moving object detected (the vehicle 2000) is within a region where the visual information is superimposed, and that the movement direction of the moving object detected (the vehicle 2000) is a direction toward a front of a screen of the input image 103.

According to the above-described configuration, the visibility for the user with respect to the moving object that is hidden by the visual information and moves in a direction toward the user can be ensured.

The image processing device 1E according to Aspect 12 of the present disclosure, in above Aspect 9, performs the switching not to superimpose the visual information in a case that the movement direction of the moving object detected (a bicycle 2100) is a direction toward a front of a screen of the input image 103.

According to the above-described configuration, the visibility for the user with respect to the moving object that moves in a direction toward the user can be ensured.

Furthermore, the image processing device according to each of the aspects of the present disclosure may be realized by a computer. In this case, an image processing program that implements the above image processing device by a computer by causing the computer to operate as each unit (software element) included in the above image processing device, and a computer-readable recording medium recording the program are also included in the scope of the present disclosure.

That is, an image processing program according to Aspect 13 of the present disclosure is an image processing program causing a processor, the processor being included in an image processing device for superimposing visual information on an input image, to perform superimposed position determination processing to determine a position at which the visual information is to be superimposed based on differential information for indicating at least one of a difference between pixel values in the input image and a difference between the input images.

An image processing program according to Aspect 14 of the present disclosure is an image processing program causing a processor, the processor being included in an image processing device for superimposing visual information on an input image, to perform non-superimposition region determination processing to determine a range in which the visual information is not to be superimposed based on differential information for indicating at least one of a difference between pixel values in the input image and a difference between the input images.

An image processing program according to Aspect 15 of the present disclosure is an image processing program causing a processor, the processor being included in an image processing device for superimposing visual information on an input image, to perform superimposition switching processing to detect a moving object from the input image, and perform switching whether to superimpose the visual information based on at least one of a position and a movement direction of the moving object detected.

The present disclosure is not limited to each of the above-described embodiments. It is possible to make various modifications within the scope of the claims. An embodiment obtained by appropriately combining technical elements disclosed in different embodiments falls also within the technical scope of the present disclosure. Further, combining technical elements disclosed in the respective embodiments can form a new technical feature.

### CROSS-REFERENCE OF RELATED APPLICATION

This application claims the benefit of priority to JP 2017-023586 filed on Feb. 10, 2017, which is incorporated herein by reference in its entirety.

### REFERENCE SIGNS LIST

1A, 1B, 1C, 1D 1E Image processing device
101 Camera
102 Imaging target
103 Input image
104a Balloon image (additional image)
104, 104c, 104′ Visual information
104b, 104d Indicating line (additional image)
200 Imaging unit
201 Control unit
202, 802, 1302 Differential information acquisition unit
203, 302 Contrast calculation unit
203, 802, 803, 1302, 1303 Non-superimposition region acquisition unit
204 Superimposition region determination unit
205 Superimposed information acquisition unit
206 Rendering unit
207 Display unit
208 Storage unit
301 Input image division unit
501 Divided region
601 Divided region group
602 Superimposition region
901, 1401 Input image read unit
902, 1402 Differential image generation unit
1001 First input image
1002 Second input image
1003 Differential image
1101 Region
1403 Focus position variation calculation unit

1-15. (canceled)

16. An image processing device comprising:
an acquiring circuitry configured to acquire an input image; and
an image processing circuitry configured to superimpose visual information on the input image, wherein
the image processing circuitry (i) determines a position at which the visual information is to be superimposed based on information for indicating a displacement of a focal position of the input image and differential information for indicating a change in time between the input images, or (ii) detects a moving object from the input image, and performs switching whether to superimpose the visual information, based on at least one of a position and a movement direction of the moving object detected.

17. The image processing device according to claim 16, wherein
the image processing circuitry determines the position at which the visual information is to be superimposed such that the visual information is not superimposed in a region having the change in time larger than a prescribed criterion.

18. The image processing device according to claim 16, wherein
the differential information includes information for indicating a displacement of a focal position of the input image, and
the image processing circuitry does not change the position at which the visual information is to be superimposed in a case that the displacement of the focal position is smaller than a prescribed criterion.

19. The image processing device according to claim 16, wherein
the image processing circuitry superimposes an additional image associated with the visual information on the input image, and
changes a shape of the additional image depending on the position, which has been determined, for superimposing the visual information.

20. The image processing device according to claim 19, wherein
the visual information is associated with a specific part of the input image, and
the image processing circuitry changes the shape of the additional image based on the specific part and the visual information into a shape that connects the specific part with the visual information.

21. The image processing device according to claim 20, wherein
the image processing circuitry changes the shape of the additional image into a shape that connects the specific part with the visual information.

22. The image processing device according to claim 16, wherein
the image processing circuitry superimposes a plurality of pieces of the visual information on the input image,
the plurality of pieces of the visual information are respectively associated with parts of the input image that are different from each other, and
the image processing circuitry determines the positions at which the plurality of pieces of the visual information are to be superimposed respectively, based on the parts of the input image that are different from each other.

23. The image processing device according to claim 22, wherein
the image processing circuitry determines the positions at which the plurality of pieces of the visual information are to be superimposed respectively such that the position at which one of the plurality of pieces of the visual information is to be superimposed is closer to the part associated with the one of the plurality of pieces of the visual information rather than the part associated with another one of the plurality of pieces of the visual information.

24. The image processing device according to claim 16, wherein
the image processing circuitry performs the switching not to superimpose the visual information in a case that the position of the moving object detected is within a region where the visual information is superimposed.

25. The image processing device according to claim 16, wherein
the image processing circuitry performs the switching not to superimpose the visual information in a case that the position of the moving object detected is within a region where the visual information is superimposed, and that the movement direction of the moving object detected is a direction toward a front of a screen of the input image.

26. The image processing device according to claim 16, wherein
the image processing circuitry performs the switching not to superimpose the visual information in a case that the movement direction of the moving object detected is a direction toward a front of a screen of the input image.

27. A non-transitory medium storing therein an image processing program for causing a computer to function as the image processing device according to claim 16, the image processing program causing the computer to function as each of the acquiring circuitry and the image processing circuitry.
